(19) United States
(12) Patent Application Publication
(10) Pub. No.: US 2009/0290883 A1
(43) Pub. Date: Nov. 26, 2009

(54) APPARATUS AND METHOD FOR ADJUSTING TONER CONSUMPTION

(75) Inventor: Nobuhiko NAKAHARA, Shizuoka-ken (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 12/126,209

(22) Filed: May 23, 2008

(51) Int. Cl. G03G 15/08

(52) U.S. Cl. 399/27

(57) ABSTRACT

An apparatus and method for controlling an amount of toner used to reproduce an image in an image forming apparatus includes receiving image data for an image to be reproduced and determining an image type for the received image data. A first toner saving function is if the determined image type is a first image type. A second toner saving function, different from the first toner saving function, is used if the determined image type is a second image type, different from the first image type.

### FIELD OF THE INVENTION

The present invention relates generally to image processing and, more particularly, to a system and method for adjusting toner consumption in an image forming apparatus.

### BACKGROUND OF THE INVENTION

The cost for hardcopy devices, such as printers, copiers and multi-function peripherals (MFPs), depends upon a number of factors. The factors include, for example, the number of pages that can be printed per minute, whether the device is color or black and white (B/W), and what system is used to generate images, such as laser or inkjet. Whereas the inkjet type hardcopy device uses ink cartridges to form images, the laser type hardcopy device uses toner to form images on a sheet or page. Depending upon the amount of use, hardcopy devices using toner must have the toner refilled periodically. If the hardcopy device is used heavily, then the repeated refilling of the toner can become a very expensive maintenance item.

It would therefore be desirable for a hardcopy device to be designed to decrease the amount of toner used and correspondingly to decrease the cost of operating and maintaining the hardcopy device.

### SUMMARY OF THE INVENTION

According to an aspect of the invention, an image forming apparatus and method for controlling an amount of toner used to reproduce an image in an image forming apparatus includes receiving image data for an image to be reproduced and determining an image type for the received image data. A first toner saving function is if the determined image type is a first image type. A second toner saving function, different from the first toner saving function, is used if the determined image type is a second image type, different from the first image type.

Further features, aspects and advantages of the present invention will become apparent from the detailed description of preferred embodiments that follows, when considered together with the accompanying figures of drawing.

### BRIEF DESCRIPTION OF THE DRAWINGS

FIG. 1 is a block diagram of an image forming apparatus consistent with the present invention.

FIG. 2 is a block diagram of a control system for the image forming apparatus of FIG. 1.

FIG. 3 is a block diagram of a toner reduction system consistent with the present invention.

FIGS. 4A and 4B are graphical representations of a color conversion process consistent with the present invention.

FIG. 5 is a graphical representation of a gamma correction process consistent with the present invention.

FIGS. 6A-6E are graphical representations of a halftone process consistent with the present invention.

FIGS. 7A and 7B are graphical representations of line thinning consistent with the present invention.

FIGS. 8A-8C are graphical representations of line smoothing consistent with the present invention.

FIGS. 9A and 9B are graphical representations of mask patterns consistent with the present invention.

FIGS. 10A-10C are graphical representations of an expansion process consistent with the present invention.

FIGS. 11A and 11B are graphical representations of a reduction process consistent with the present invention.

FIG. 12 is a block diagram of a black generation/under color removal system consistent with the present invention.

FIG. 13 is a flow diagram of a toner reduction process consistent with the present invention.

FIG. 14 is a block diagram of an apparatus consistent with an embodiment of the present invention.

FIG. 15 is a block diagram of an apparatus consistent with another embodiment of the present invention.

FIG. 16 is a block diagram of an apparatus consistent with yet another embodiment of the present invention.

### DETAILED DESCRIPTION OF PREFERRED EMBODIMENT

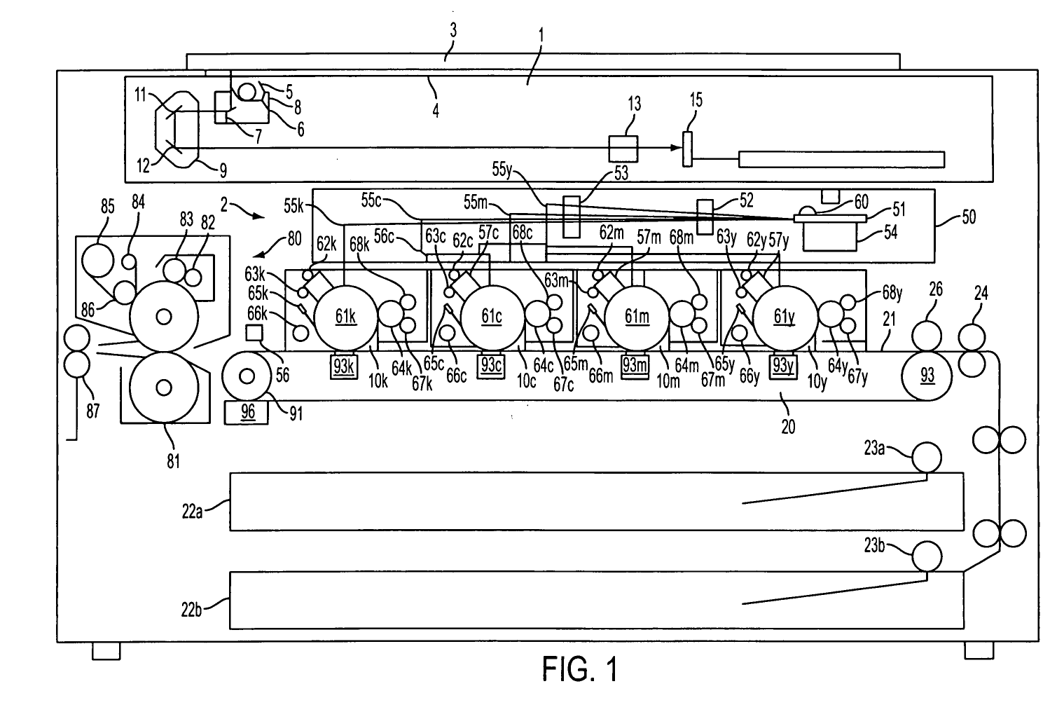

FIG. 1 shows a block diagram of an image forming apparatus consistent with the present invention. The image forming apparatus may be a hardcopy device such as a digital type color copier for forming a copied image of a color image. As shown in FIG. 1, the image forming apparatus includes a color scanner portion 1, which scans and reads a color image on a document and a color printer portion 2, which forms a copied image of the color image.

The color scanner portion 1 includes a document base cover 3 at an upper portion thereof. A document base 4 is arranged opposite to the document base cover 3 in a closed state and includes transparent glass on which the document is set. On a lower side of the document base 4 are arranged an exposure lamp 5 for illuminating the document mounted on the document base 4, a reflector 6 for focusing light from the exposure lamp 5 to the document and a first mirror 7 for reflecting the light from the document. The exposure lamp 5, the reflector 6 and the first mirror 7 are fixed to a first carriage 8. The first carriage 8 is moved by a pulse motor, not illustrated, along a lower face of the document base 4.

A second carriage 9 is arranged in a direction in which the light is reflected by the first mirror 7 and provided movably in parallel with the document base 4 via a drive mechanism, such as a belt with teeth in conjunction with a direct current motor or the like. The second carriage 9 includes a second mirror 11 for reflecting the light from the first mirror 7 to a third mirror 12. The third mirror 12 then reflects the light from the second mirror 11. The second carriage 9 is driven by the first carriage 8 and is moved along the document base 4 in parallel therewith at half the speed of the first carriage 8.

A focusing lens 13 focuses the light reflected from the third mirror 12 by a predetermined magnification. A CCD type color image sensor or photoelectric conversion element 15 converts the reflected light focused by the focusing lens 13 into an electric signal.

When light from the exposure lamp 5 is focused on the document on the document base 4 by the reflector 6, the reflected light from the document is made to be incident on the color image sensor 15 via the first mirror 7, the second mirror 11, the third mirror 12 and the focusing lens 13. At the color image sensor 15, the incident light is converted into an electric signal in accordance with the three primary colors of light of R (red), G (green) and B (blue).

The color printer portion 2 includes first through fourth image forming portions 10y, 10m, 10c and 10k. These image forming portions form images that are subjected to color decomposition for respective color components. In particular, the images are decomposed into the four colors of yellow (y), magenta (m), cyan (c) and black (k) according to known decomposition methods, such as the subtractive mixing method.

A transfer mechanism 20, which includes a transfer belt 21, transfers the images of the respective colors formed by the respective image forming portions in a direction shown by the arrow marked “a” in FIG. 1. The transfer belt 21 is wound to expand between a drive roller 91 rotated by a motor in the direction shown by the arrow marked “a,” and a drive roller 92 separated from the drive roller 91 by a predetermined distance rotating at a constant speed in the direction of the arrow marked “a.” The image forming portions 10y, 10m, 10c and 10k are arranged in series along a transfer direction of the transfer belt 21.

The image forming portions 10y, 10m, 10c and 10k include photosensitive drums 61y, 61m, 61c and 61k, respectively, as image carriers. Outer peripheral faces of the drums are formed in the same direction at respective positions in contact with the transfer belt 21. The photosensitive drums 61y, 61m, 61c and 61k are rotated at a predetermined speed by a motor (not shown).

The photosensitive drums 61y, 61m and 61c and 61k are arranged such that their axis lines are respectively disposed at equal intervals and are arranged such that the axis lines are orthogonal to the direction that the images are transferred by the transfer belt 21. The directions of the axis lines of the photosensitive drums 61y, 61m, 61c and 61k are defined as main scanning directions (second direction). The rotational directions of the photosensitive drums 61y, 61m, 61c and 61k, which correspond to a rotational direction of the transfer belt 21 (the arrow marked “a”), are defined as sub-scanning directions (first direction).

Electricity charging apparatus 62y, 62m, 62c and 62k, electricity removing apparatus 63y, 63m, 63c and 63k and developing rollers 64y, 64m, 64c and 64k are all extended in the main scanning direction. Lower agitating rollers 67y, 67m, 67c and 67k, upper agitating rollers 68y, 68m, 68c and 68k, transcribing apparatus 93y, 93m, 93c and 93k, and cleaning blades 65y, 65m, 65c and 65k also extend in the main scanning direction. Discharged toner recovery screws 66y, 66m, 66c and 66k are arranged successively along the rotational direction of the photosensitive drums 61y, 61m, 61c and 61k.

Transcribing apparatus 93y, 93m, 93c and 93k are arranged at positions sandwiching the transfer belt 21 between them. Corresponding ones of the photosensitive drums 61y, 61m, 61c and 61k are arranged on an inner side of the transfer belt. Further, exposure points by an exposure apparatus 50 are respectively formed on the outer peripheral faces of the photosensitive drums 61y, 61m, 61c and 61k between the electricity charging apparatus 62y, 62m, 62c and 62k and developing rollers 64y, 64m, 64c and 64k.

Sheet cassettes 22a and 22b are arranged on a lower side of the transfer mechanism 20 and contain sheets of the sheet P as image forming media for transcribing images formed by the respective image forming portions 10y, 10m, 10c and 10k. Pickup rollers 23a and 23b are arranged at end portions on one side of the sheet cassettes 22a and 22b and on sides thereof proximate to the drive roller 92. Pickup rollers 23a and 23b pick up the sheet P contained in the sheet cassettes 22a and 22b sheet by sheet from topmost portions of the sheets. A register roller 24 is arranged between the pickup rollers 23a and 23b and the drive roller 92. The register roller 24 matches a front end of the sheet P picked from the sheet cassette 22a or 22b and a front end of a toner image formed at the photosensitive drum 61y of the image forming portion 10y. Toner images formed at the other photosensitive drums 61y, 61m and 61c are supplied to respective transcribing positions in conformity with transfer timings of the sheet P transferred on the transfer belt 21.

An adsorbing roller 26 is arranged between the register roller 24 and the first image forming portion 10y, at a vicinity of the drive roller 92, such as above an outer periphery of the drive roller 92 substantially pinching the transfer belt 21. The adsorbing roller 26 provides electrostatic adsorbing force to the sheet P transferred at predetermined timings via the register roller 24. The axis line of the adsorbing roller 26 and the axis line of the drive roller 92 are set to be in parallel with each other.

A positional shift sensor 96 is arranged at one end of the transfer belt 21, and at a vicinity of the drive roller 91, such as above an outer periphery of the drive roller 91 substantially pinching the transfer belt 21. The positional shift sensor 96 detects a position of the image formed on the transfer belt 21. The positional shift sensor 96 may be implemented, for example, as a transmitting type or a reflecting type optical sensor.

A transfer belt cleaning apparatus 95 is arranged on an outer periphery of the drive roller 91 and above the transfer belt 21 on the downstream side of the positional shift sensor 96. The transfer belt cleaning apparatus 95 removes toner or paper dust off the sheet P adhered onto the transfer belt 21.

A fixing apparatus 80 is arranged to receive the sheet P when it detaches from the transfer belt 21 and transfers the sheet P further. The fixing apparatus 80 fixes the toner image on the sheet P by melting the toner image transcribed onto the sheet P by heating the sheet P to a predetermined temperature. The fixing apparatus 80 includes a pair of heat rollers 81, oil coating rollers 82 and 83, a web winding roller 84, a web roller 85 and a web pressing roller 86. After the toner formed on the sheet P is fixed to the sheet, the sheet P is discharged by a paper discharge roller pair 87.

The exposure apparatus 50 forms electrostatic latent images subjected to color decomposition on the outer peripheral faces of the photosensitive drums 61y, 61m, 61c and 61k. The exposure apparatus is provided with a semiconductor laser oscillator 60 controlled to emit light based on image data (Y, M, C, K) for respective colors subjected to color decomposition by an image processing apparatus 36.

On an optical path of the semiconductor laser oscillator 60, there are successively provided a polygonal mirror 51 rotated by a polygonal motor 54 for reflecting and scanning a laser beam light and fθ lenses 52 and 53 for correcting and focusing a focal point of the laser beam light reflected via the polygonal mirror 51. First folding mirrors 55y, 55m, 55c and 55k are arranged between the fθ lens 53 and the photosensitive drums 61y, 61m, 61c and 61k. The first folding mirrors 55y, 55m, 55c and 55k fold or reflect the laser beam light of respective colors that have passed through the fθ lens 53 toward the exposure positions of the photosensitive drums 61y, 61m, 61c and 61k. Second and third folding mirrors 56y, 56m, 56c and 57y, 57m and 57c further fold or reflect the laser beam light folded by the first folding mirrors 55y, 55m and 55c. The laser beam light for black is folded or reflected by the first folding mirror 55k and thereafter guided onto the photosensitive drum 61k without detouring other mirrors.

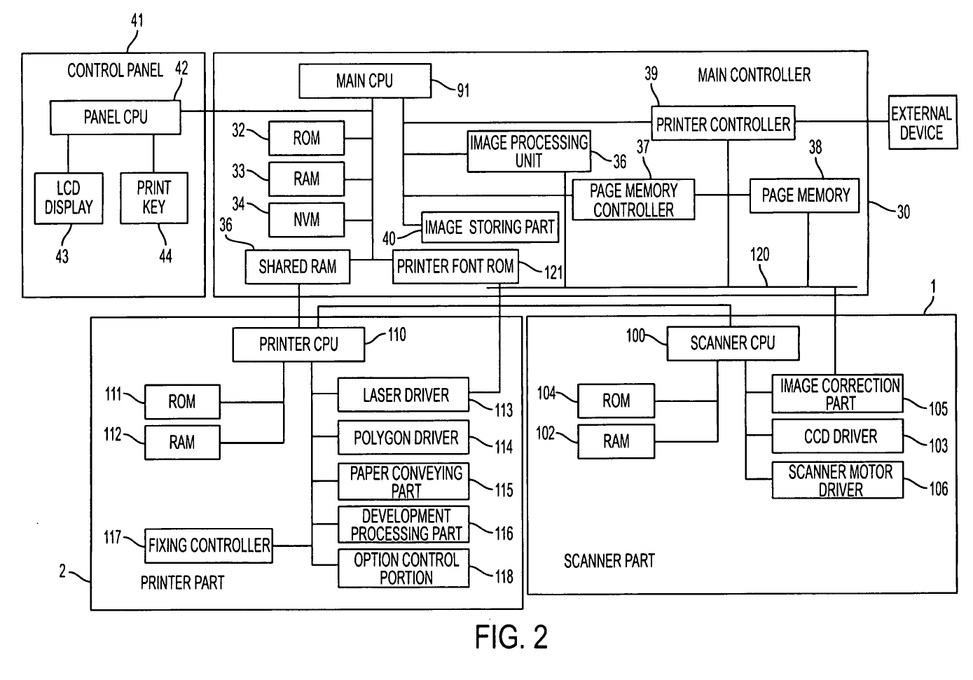

FIG. 2 shows a block diagram of a control system for the image forming apparatus of FIG. 1. In FIG. 2, the control system includes three CPUs: a main CPU (Central Processing Unit) 91 in a main control portion 30; a scanner CPU 100 of the color scanner portion 1; and a printer CPU 110 of the color printer portion 2. The main CPU 91 carries out bidirectional communication with the printer CPU 110 via a common ROM (Random Access Memory) 35. The main CPU 91 issues operation instructions, and the printer CPU 110 returns state statuses. The printer CPU 110 and the scanner CPU 100 carry out serial communication. The printer CPU 110 issues operation instructions, and the scanner CPU 100 returns state statuses.

An operation panel 41 includes a liquid crystal display portion 43, various operation keys 44 and a panel CPU 42. The operation panel 41 is connected to the main CPU 91. The main control portion 30 includes the main CPU 91, a ROM (Read Only Memory) 32, a RAM 33, an NVRAM 34, the common RAM 35, the image processing apparatus 36, a page memory control portion 37, a page memory 38, a printer controller 39, an image storing part 40 and a printer font ROM 121.

The main CPU 91 controls the main control portion 30. The ROM 32 is stored with control programs. The RAM 33 is for temporarily storing data. The NVRAM (Nonvolatile Random Access Memory: Nonvolatile RAM) 34 is a memory backed up with a battery (not illustrated) for holding stored data even when a power source is cut. The common or shared RAM 35 is for carrying out bidirectional communication between the main CPU 91 and the printer CPU 110.

The page memory control portion 37 stores and reads image information to and from the page memory 38. The page memory 38 includes an area capable of storing a plurality of pages of image information and is formed to be able to store data compressed with image information from the color scanner portion 1 for each compressed page.

The printer font ROM 121 is stored with font data in correspondence with the print data. The printer controller 39 develops printer data from an outside apparatus 122, such as a personal computer, into image data. The printer controller uses the font data stored in the printer font ROM 121 at a resolution in accordance with data indicating a resolution included in the printer data.

The color scanner portion 1 includes the scanner CPU 100, which controls the color scanner portion 1. The color scanner portion also includes a ROM 104 stored with control programs, a RAM 102 for storing data, a CCD driver 103 for driving the color image sensor 15, a scanning motor driver 106 for controlling rotation of a scanning motor and moving the first carriage 8, and an image correcting portion 105. The image correcting portion 105 includes an A/D conversion circuit for converting analog signals of R, G and B outputted from the color image sensor 15 respectively into digital signals, a shading correction circuit for correcting a dispersion in a threshold level with respect to an output signal from the color image sensor 15 caused by a variation in the color image sensor 15 or surrounding temperature change, and a line memory for temporarily storing the digital signals subjected to shading correction from the shading correction circuit.

The color printer portion 2 includes the printer CPU 110, which controls the color printer portion 2. The color printer portion 2 also includes a ROM 111 stored with control programs, a RAM 112 for storing data, the laser driver 113 for driving the semiconductor laser oscillator 60, a polygonal motor driver 114 for driving the polygonal motor 54 of the exposure apparatus 50, and a transfer control portion 115 for controlling the transfer of the sheet P by the transfer mechanism 20.

The color printer portion 2 further includes a process control portion 116, a fixing control portion 117 for controlling the fixing apparatus 80, and an option control portion 118 for controlling options. The process control portion 116 controls processes for charging electricity, developing and transcribing by use of the electricity charging apparatus, the developing roller and the transcribing apparatus. The image processing portion 36, the page memory 38, the printer controller 39, the image correcting portion 105 and the laser driver 113 are connected to each other by an image data bus 120.

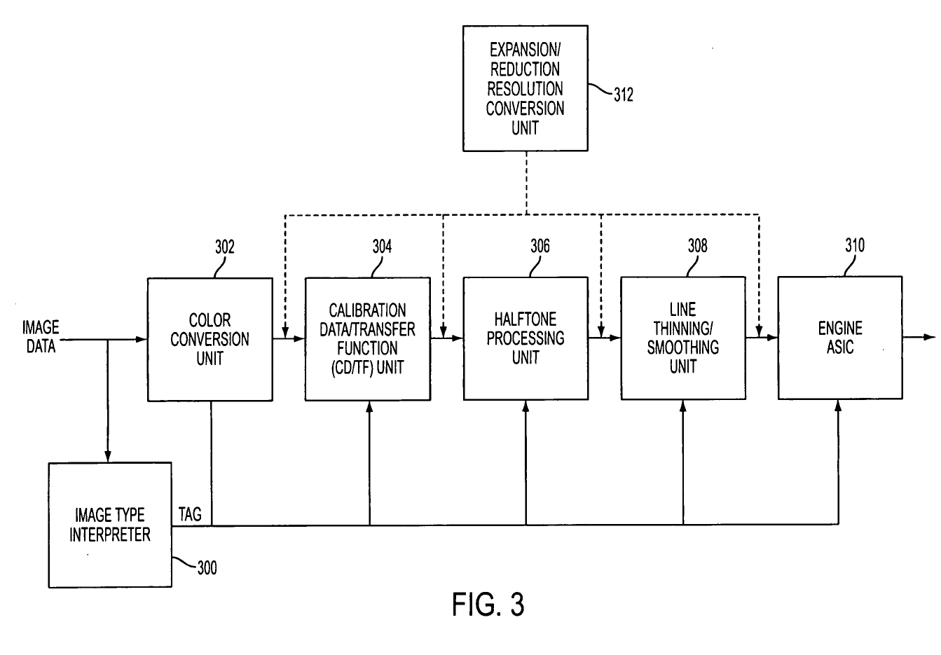

FIG. 3 is a block diagram of a toner reduction system consistent with the present invention. The toner reduction system can be implemented in an image forming apparatus or in a device in communication with the image forming apparatus. In addition, each element of the toner reduction system may be implemented in software, in hardware, or a combination of the two. As shown in FIG. 3, the toner reduction system includes an image type interpreter 300, a color conversion unit 302, a calibration data/transfer function (CD/TF) unit 304, a halftone processing unit 306, a line thinning/smoothing unit 308, an engine ASIC 310, and an expansion/reduction resolution conversion unit 312. Each element may be ordered differently than as shown in FIG. 3, e.g., the CD/TF unit 304 may be before the color conversion unit 302. More specifically, the elements may be positioned differently than the order shown in FIG. 3 and can be configured to perform their processing functions in a different order than the order shown in FIG. 3. Further, as described in more detail herein, during a toner reduction process, just one of the elements, a subset of all of the elements, or all of the elements of the toner reduction system can be used.

Image data can provided to the toner reduction system of FIG. 3 from a scanning unit, such as the color scanner portion 1 of FIG. 1, from a storage area of the image forming apparatus, from a PC, server, or workstation coupled to the toner reduction system, or any other source of image data in communication with the toner reduction system. The image data can be color (such as RGB data) or black and white (B/W), and in any type of image format, such as JPEG, GIF or other formats.

The image data received by the toner reduction system are provided to the image type interpreter 300. The image type interpreter 300 is configured to determine the image type of the image data. The image type can be, for example, text, graphics, photo, or other known image types. In general, the image type can be determined according to the content of the image data itself. More specifically, to make the image type determination, the image type interpreter 300 can be configured to analyze the image data using any of a number of available algorithms or processes as are known to one skilled in the art for determining image type.

As a result of the determination, the image type interpreter 300 generates a tag indicative of the determined image type of the received image data. As shown in FIG. 3, the tag is provided to the color conversion unit 302, the CD/TF unit 304, the halftone processing unit 306, the line thinning/smoothing unit 308, and the engine ASIC 310. Although not shown, the tag can also be provided to the expansion/reduction resolution conversion unit 312. It is also possible for the tag to be provided to a subset or only one of the elements of the toner reduction system. As will be described in greater detail below, the tag can be used to determine if an element of the toner reduction system should process the image data in a toner saving mode or in a standard mode.

The color conversion unit 302 is preferably configured to perform color conversion and color mapping or matching. In general, color conversion converts image data from an original color space to a destination color space, such as from RGB to CMYK. Since colors in a particular color space are fixed relative to that color space's white point and the white point of a color space varies from device to device, a converted color is typically matched to its visually closest color in the destination color space. Color mapping corresponds to this process of matching the converted color to its visually closest color in the destination color space.

For example, if a user displays an image on a display, the image is typically displayed in the RGB color space corresponding to the particular display. To print the image on the display, the image data typically is converted from the RGB color space of the display to a CMYK color space of the printer. More specifically, the color conversion process converts the RGB image data to the CMYK image data. In addition, the color mapping process matches the CMYK image data to the closest color that the printer can produce.

The color conversion and matching processes preferably take into account other device-dependent factors including, for example, the number of bits per pixel, the colorants (e.g., inks and toners) used for printing, the printer resolution, and gamma correction. These device-dependent factors contribute to defining the particular set of colors that the device can produce. This set of colors is typically referred to as the gamut. The gamut relates primarily to the color mapping process. More specifically, to perform the color conversion and mapping, the image data is converted from a color space and gamut of the source device into the color space of the destination device. The converted image data is then matched into the gamut of the destination device.

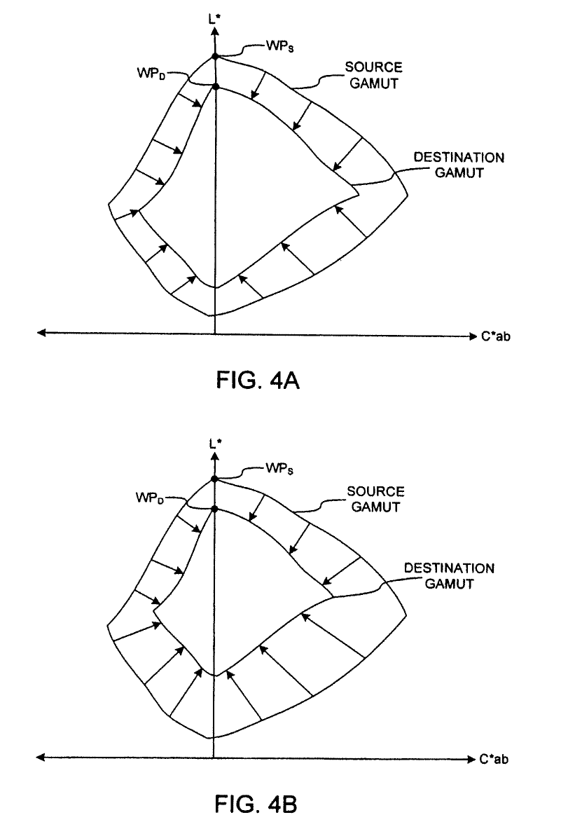

FIGS. 4A and 4B are graphical representations of a color conversion process consistent with the present invention showing the gamuts of source and destination devices that can be used by the color conversion unit 302. More specifically, FIG. 4A shows the source and destination gamuts in a standard mode, and FIG. 4B shows the source and destination gamuts in a toner saving mode. In each figure, the vertical axis corresponds to the L* value, and the horizontal axis corresponds to the C*ab value, the L* and C*ab values representing an actual physical luminescence value. In addition, WP_{S} represents the white point of the source gamut, and WP_{D} represents the white point of the destination gamut.

The source gamut in FIGS. 4A and 4B are identical and are exemplary of the set of colors that can be produced by a specific source device, such as a particular display (for different displays or different device types, the gamut would likely be different). The destination gamuts in FIGS. 4A and 4B are exemplary of the set of colors that can be produced by a printer, such as the color printer portion 2 of the image forming apparatus of FIG. 1. Although the destination gamuts have the same shape, they are not identical. Rather, the destination gamut of FIG. 4A, corresponding to the standard mode, is larger than the destination gamut of FIG. 4B, corresponding to the toner saving mode. The smaller destination gamut of FIG. 4B means that the set of colors that can be produced by the printer is reduced, which preferably results in a reduction of the amount of toner used by the printer to reproduce the image data.

In operation, the color conversion unit 302 can determine which destination gamut to use for color conversion and mapping based on the tag received from the image type interpreter 300. For example, for some image types, the destination gamut of FIG. 4A can be used, and for other image types, the destination gamut of FIG. 4B can be used. The color conversion unit 302 can also be responsive to a setting of the image forming apparatus identifying whether the image data should be reproduced in a standard mode or a toner saving mode. The setting can be provided by the user requesting image reproduction or can be a default parameter of the image forming apparatus set by a user or technician. If in the standard mode, then the destination gamut of FIG. 4A is used, whereas the destination gamut of FIG. 4B is used if in the toner saving mode. Even if in the toner saving mode, the destination gamut of FIG. 4A may still be used if the tag identifies the image data as being a particular type for which toner saving should not be applied by the color conversion unit 302.

The CD/TF unit 304 is preferably configured to perform several image processing functions including, for example, gamma correction. In general, gamma represents the way brightness is distributed across the intensity spectrum by a monitor, printer or scanner. More specifically, gamma corresponds to the relationship between the input voltage and resulting intensity of the output. A perfect linear device would have a gamma of 1.0 and be plotted on a graph called a “tone curve” as a straight line. Whereas a scanner is fairly linear, the tone curve of a monitor or printer is bent, yielding a gamma in the range of 1.8 to 2.6, which effects midrange tones. Gamma correction adjusts the light intensity (brightness) of a scanner, monitor or printer in order to match the output more closely to the original image. To do so, a gamma correction process imposes the complement of the “tone curve” in order to flatten the line and bring the gamma closer to the ideal 1.0

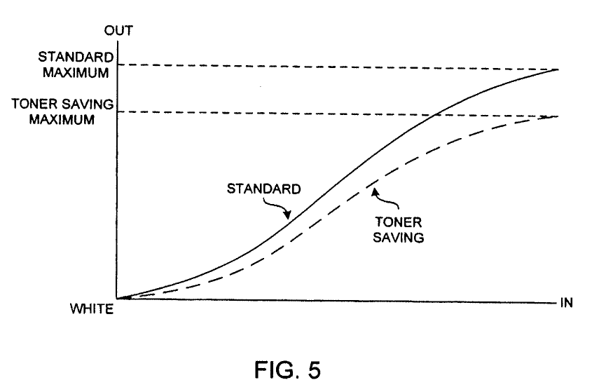

FIG. 5 is a graphical representation of a gamma correction process consistent with the present invention that can be used by the CD/TF unit 304. As shown in FIG. 5, there are two gamma correction curves, one for a standard mode, and one for a toner saving mode. In the standard mode, the gamma correction curve has a conventional shape with a maximum corresponding to a maximum black level used for reproduction. In the toner saving mode, the gamma correction curve has a similar shape, but with a lower maximum than the standard mode gamma correction curve. In addition, the toner saving gamma correction curve is positioned lower than the standard gamma correction curve. The combination of the reduced maximum and lower positioning of the toner saving gamma correction curve results in a reduction in the amount of toner used in the toner saving mode with respect to the corresponding amount of toner used in the standard mode.

Similar to the color conversion unit 302, the CD/TF unit 304 can determine which gamma correction curve to use based on the tag received from the image type interpreter 300. For example, for some image types, the standard mode gamma correction curve can be used, and for other image types, the toner saving gamma correction curve can be used. The CD/TF unit 304 can also be responsive to a setting of the image forming apparatus identifying whether the image data should be reproduced in a standard mode or a toner saving mode, and thus use the standard or toner saving gamma correction curve, respectively. Even if in the toner saving mode, the destination gamut of FIG. 4A may be used if the tag identifies the image data as being a particular type for which toner saving should not be applied by the CD/TF unit 304.

The halftone processing unit 306 is preferably configured to perform a halftoning of the image data. Typically, halftoning is a method of printing shades using a single color ink but can also be used for printing color images. By varying the size or density of the dots, the eye can see a shade somewhere between the solid color and the color of the background paper. However, if the dots get too small or spaced too far apart, the eye starts seeing dots again. For color images, the general idea of halftoning is the same, i.e., by varying the density of the four primary printing colors, cyan, magenta, yellow and black, any particular shade can be reproduced. The halftoning generates a pattern of dots that is used to represent a particular shade, which is typically referred to as a halftone screen.

To perform the halftoning, the halftone processing unit 306 uses a halftone pattern. A typical halftone pattern applies a threshold value for each pixel of the image data. The threshold value is compared to the corresponding color level of the pixel. For example, for black and white image data, the K or black value may be between 0 and 255, and the threshold corresponds to a value somewhere between 0 and 255. If the color level of the pixel of the image data is less than (or equal to) the corresponding threshold of the halftone pattern, then the halftone processing unit 306 makes the color level for that pixel of the image data a zero value representing white. Conversely, if the color level of the pixel of the image data is greater than (or equal to) the corresponding threshold of the halftone pattern, then the halftone processing unit 306 makes the color level for that pixel of the image data a one value representing black.

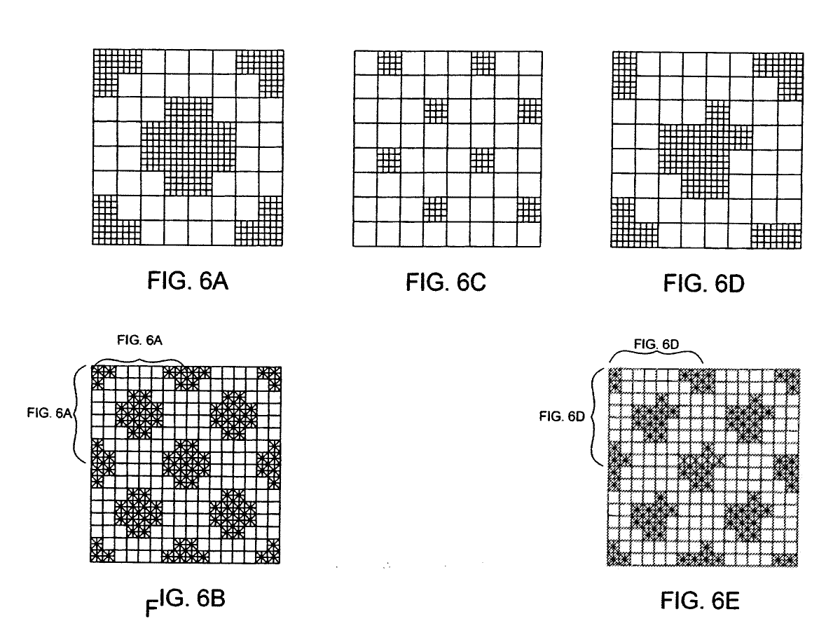

FIGS. 6A-6E are graphical representations of a halftone process consistent with the present invention that can be used by the halftone processing unit 306. In each of these figures, each box represents a pixel, an empty box corresponds to a white or zero value, and a filled in box corresponds to a black or one value. FIG. 6B shows an example of a result of a standard halftone process applied to image data, and FIG. 6A shows an expanded version of a portion of the result shown in FIG. 6B. In a standard mode, the result of FIG. 6B is output from the halftone processing unit 306.

FIG. 6C is a graphical representation of an exemplary mask that can be applied to the result of the halftone processing (i.e., the application of the halftone pattern to the image data). As shown in FIG. 6C, the filled-in boxes or pixels represent the set or mask portions. Although the mask of FIG. 6C is arranged periodically, i.e., in a predictable pattern, the mask can also be arranged randomly or stochastically.

FIG. 6E represents a result of applying the mask of FIG. 6C to the result of the halftone processing shown in FIG. 6B, and FIG. 6D shows an expanded version of a portion of the result shown in FIG. 6E. As shown in FIG. 6D, if a pixel of the result of the halftone processing shown in FIG. 6A has a black or one value and corresponds to a pixel set in the mask of FIG. 6C, then the pixel is converted to a white or zero value. For example, the black pixel in the third row and fourth column of FIG. 6A is converted to a white pixel in the same position in FIG. 6D because the pixel is set in that position in the mask of FIG. 6C. Applying the mask to the result of the halftone processing thus results in fewer black (or color) pixels output from the halftone processing unit 306, which correspondingly reduces the amount of toner used to reproduce the image.

The halftone processing unit 306 can determine whether to apply the mask to the result of the halftone processing based on the tag received from the image type interpreter 300. For example, the mask can be applied for some image types but not for others. The halftone processing unit 306 can also be responsive to a setting of the image forming apparatus identifying whether the image data should be reproduced in a standard mode or a toner saving mode, and thus apply the mask only if in the toner saving mode. Even if in the toner saving mode, the mask may not be applied if the tag identifies the image data as being a particular type for which toner saving should not be applied by the halftone processing unit 306.

The line thinning/smoothing unit 308 is preferably configured to perform line thinning for horizontal and/or vertical lines and to perform line smoothing for angled, inclined or slanted lines. Line thinning is a process of reducing the thickness of a line being reproduced. Line smoothing is a process of adjusting edges of a slanted line so that the edges look smoother.

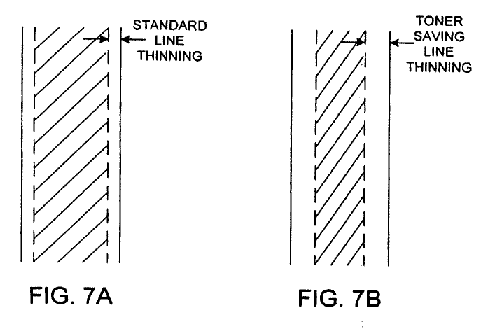

FIGS. 7A and 7B are graphical representations of line thinning consistent with the present invention. More specifically, FIG. 7A shows a standard line thinning performed in a standard mode, and FIG. 7B shows a toner saving line thinning performed in a toner saving mode. In FIG. 7A, the solid vertical lines represent the edges of the line according to the original image data, and the vertical dashed lines represent the edges of the line after performing line thinning. The slanted hashing lines represent the line being reproduced after performing line thinning.

In the line thinning processes of FIGS. 7A and 7B, the line is thinned by a predetermined amount, such as a certain percentage of the original line or a certain thickness for each line regardless of the thickness of the original line. The predetermined amount may be a fixed value or be settable by a user or technician. In addition, each process thins the line equally on each side of the line. It is possible, however, for the line to be thinned by removing or deleting only one side of the line. Although the standard line thinning process and toner saving line thinning process both reduce the thickness of the line, the toner saving line thinning process reduces the thickness of the line more than the standard line thinning process. As a result, less toner is needed to reproduce a line if the toner saving line thinning process is applied.

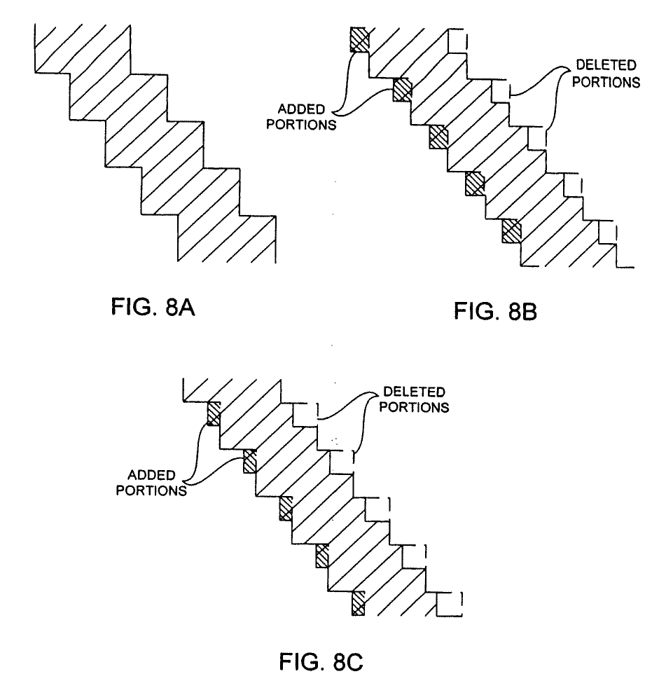

FIGS. 8A-8C are graphical representations of line smoothing consistent with the present invention. FIG. 8A represents an example of a slanted line produced according to the original image data. FIG. 8B represents an example of the slanted line resulting from a standard line smoothing process. FIG. 8C represent an example of the slanted line resulting from a toner saving line smoothing process. In FIGS. 8B and 8C, the hashing sloping down from left to right represents portions added to the slanted line FIG. 8A, and each empty box defined in part by a dashed line represents a portion deleted from the slanted line of FIG. 8A.

In both the standard line smoothing process of FIG. 8B and the toner saving line smoothing process of FIG. 8C, a portion is added to the slanted line of FIG. 8A, and a portion is deleted from the slanted line of FIG. 8B. In FIG. 8B, the added portions and the deleted portions are the same size. As a result, the standard line smoothing process of FIG. 8B uses the same amount of toner as used for the original slanted line of FIG. 8A, but produces a smoother line than that of FIG. 8A. In contrast, the added portions and deleted portions in FIG. 8C are not the same. Rather, the added portions in FIG. 8C are smaller than the deleted portions, resulting in less toner used to reproduced the slanted line as compared to the original slanted line of FIG. 8A.

The line thinning/smoothing unit 308 can determine which line thinning and smoothing process to use based on the tag received from the image type interpreter 300. For example, the standard line thinning and smoothing process can be applied for some image types, and the toner saving line thinning and smoothing process for other image types. The line thinning/smoothing unit 308 can also be responsive to a setting of the image forming apparatus identifying whether the image data should be reproduced in a standard mode or a toner saving mode, and thus use the standard or toner saving line thinning and smoothing processes, respectively. Even if in the toner saving mode, the standard line thinning of FIG. 7A and standard line smoothing of FIG. 8B may be used if the tag identifies the image data as being a particular type for which toner saving should not be applied by the line thinning/smoothing unit 308.

The engine ASIC 310 is preferable configured to apply a mask to the image data. The mask includes a plurality of set pixels. When applying the mask, if a set pixel of the mask corresponds to a pixel of the image data, then the corresponding pixel of the image data is reset or cleared. For example, if the image data is black and white data, and a set pixel of the mask corresponds to a black pixel of the image data, then that black pixel is reset or cleared to be a white pixel.

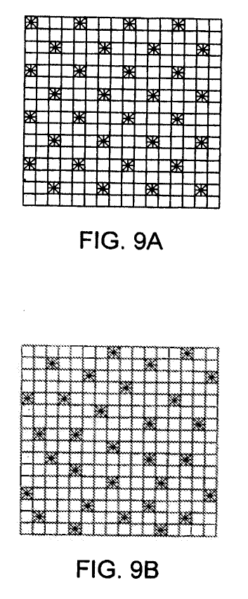

FIGS. 9A and 9B are graphical representations of mask patterns consistent with the present invention. More specifically, FIG. 9A shows a mask pattern having a periodic or predictable pattern, and FIG. 9B shows a mask pattern having a random or stochastic pattern. Applying the stochastic mask pattern of FIG. 9B to the image data is analogous to applying an error diffusion process to the image data. In addition, using the stochastic mask pattern of FIG. 9B typically results in a better output image than the periodic mask pattern of FIG. 9A

The engine ASIC 310 can determine which mask pattern to apply to the image data based on the tag received from the image type interpreter 300. For example, the periodic mask pattern can be applied for some image types, and the stochastic mask pattern for other image types. The engine ASIC 310 can also be responsive to a setting of the image forming apparatus identifying whether the image data should be reproduced in a standard mode or a toner saving mode, and thus use the periodic or stochastic mask pattern, respectively. Even if in the toner saving mode, the periodic mask pattern of FIG. 9A may be used if the tag identifies the image data as being a particular type for which toner saving should not be applied by the engine ASIC 310.

The expansion/reduction resolution conversion unit 312 is preferably configured to perform expansion or reduction of the image data. The expansion or reduction of the image data can be determined in accordance with a setting of the request to print or reproduce the image data. For example, if making a copy of a document, a user may enter a setting in the copy request that the original image be expanded or reduced. Similarly, a user may enter a setting in a print request that the image data be expanded or reduced. In an expansion process, the expansion/reduction resolution conversion unit 312 typically multiplies or expands each pixel of the original image data into two or more pixels. Conversely, in a reduction process, the expansion/reduction resolution conversion unit 312 combines two or more pixels of the original image data into a single pixel.

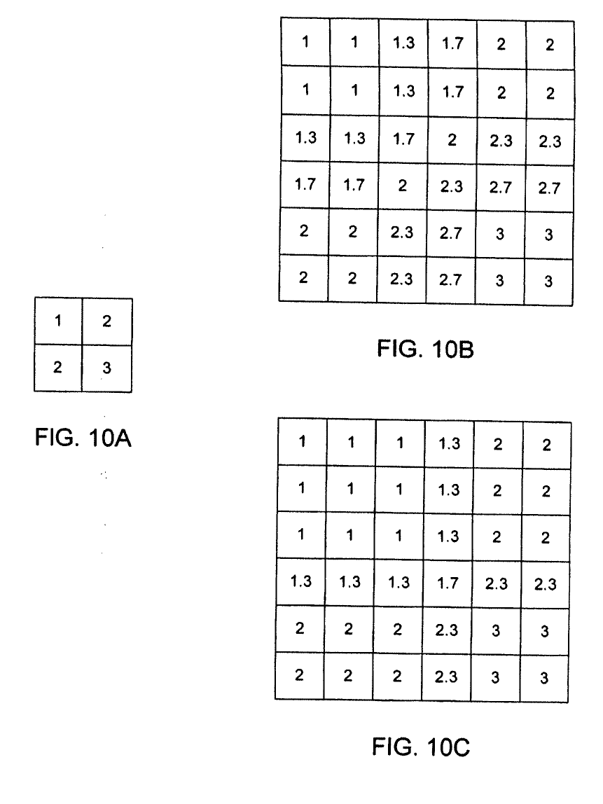

FIGS. 10A-10C are graphical representations of an expansion process consistent with the present invention. In FIGS. 10A-10C, the numbers represent color densities of a corresponding pixel, where a ‘1’ represents the lowest density, and a higher value represents a correspondingly higher density. FIG. 10A shows an example of pixels from the original image data. FIG. 10B shows an example of the pixels of FIG. 10A expanded three times (i.e., 1:3) according to a standard mode. FIG. 10C shows an example of the pixels of FIG. 10A expanded three times according to a toner saving mode. Thus, each pixel of FIG. 10A corresponds to a 3×3 block of pixels in FIG. 10B and in FIG. 10C.

To determine the color densities of each pixel in the expanded image data of FIG. 10B and FIG. 10C, the color density of the central pixel in each block is made equal to the color density of the corresponding pixel of the original image data. For example, for the block corresponding to the top left pixel of FIG. 10A having a color density of one, the center pixel of the block is made equal to one. This block of pixels corresponds to the pixels in the top three rows and the left three columns. Thus, the center pixel of the block corresponds to the pixel in row two and column two (i.e., (2,2) where the first value is row and the second value is column), which has a color density of ‘1’ as shown in FIGS. 10B and 10C. Correspondingly, the center pixel for the block corresponding to the top right pixel of FIG. 10A is located at (2,5) in FIGS. 10B and 10C, the center pixel for the block corresponding to the bottom left pixel of FIG. 10A is located at (5,2) in FIGS. 10B and 10C, and the center pixel for the block corresponding to the bottom right pixel of FIG. 10A is located at (5,5) in FIGS. 10B and 10C.

In addition to these center pixels of each block, the color density of three other pixels in each block are also made equal to the color density of the corresponding pixel in the original image data of FIG. 10A. For example, in the 3×3 block in the top left of FIGS. 10B and 10C, the color density of the pixels to the left, above, and above left are each made equal to one. Correspondingly, in the 3×3 block in the top right of FIGS. 10B and 10C, the color density of the pixels to the right, above, and above right are each made equal to two. The same follows in the appropriate manner for the other two 3×3 blocks.

The standard mode expansion of FIG. 10B and the toner saving mode expansion of FIG. 10C differ in the manner in which the color density of the remaining pixels are determined. In FIG. 10B, the color density of the remaining pixels are determined in a bi-linear manner according to the color densities of pixels having already determined color densities. For example, to determine the color density of the two pixels between pixel (2,2) and pixel (2,5), the color densities are chosen as a linear progression between the color density of one for pixel (2,2) and the color density of two for pixel (2,5), which results in a color density of 1.3 for pixel (2,3) and a color density of 1.7 for pixel (2,4). The same linear progression is used to determine the color density of each pair of pixels located in a line between a pair of pixels having already determined color densities, e.g., pixels (3,2) and (4,2) between pixels (2,2) and (5,2), pixels (6,3) and (6,4) between pixels (6,2) and (6,5), etc.

In the toner saving mode expansion of FIG. 10C, the color density of the remaining pixels are made lower than the corresponding color densities of the remaining pixels in FIG. 10B. Similar to the standard mode expansion of FIG. 10B, the color densities of the remaining pixels in the toner saving mode expansion of FIG. 10C are determined in accordance with the color densities of a pair of pixels having already determined color densities. In general, to determine the color densities of the two pixels intervening the pair of pixels having already determined color densities, the color density of the intervening pixel closer to the pixel having the lower color density is made equal to that lower color density. The color density of the other intervening pixel is made equal to that lower color density plus a fraction (such as one third) of the difference between the color densities of the pair of pixels having already determined color densities. For example, for the two pixels intervening pixel (2,2) and pixel (2,5), the color density of pixel (2,3) is made equal to the color density of pixel (2,2), and the color density of pixel (2,4) is made equal to the color density of pixel (2,2) plus one third of the difference between the color densities of pixels (2,2) and (2,6). Since the color densities of the pixels in the toner saving mode expansion of FIG. 10C are lower than the color densities of many of the corresponding pixels in the standard mode expansion of FIG. 10B, the toner saving mode expansion uses less toner to reproduce the expanded image.

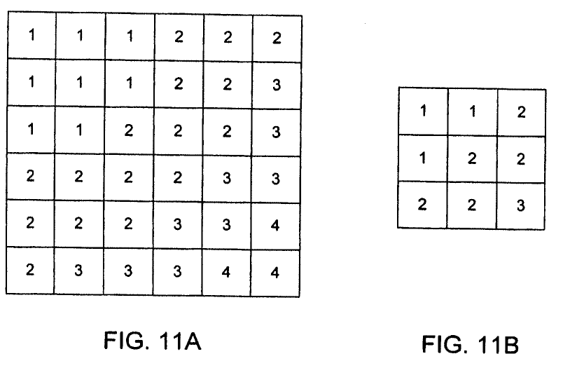

FIGS. 11A and 11B are graphical representations of a reduction process consistent with the present invention. Like FIGS. 10A-10C, the numbers in FIGS. 11A and 11B represent color densities of a corresponding pixel, where a ‘1’ represents the lowest density, and a higher value represents a correspondingly higher density. FIG. 11A shows an example of pixels from the original image data. FIG. 11B shows an example of the pixels of 11A reduced by one half (i.e., 2:1) according to a toner saving mode. Thus, each 2×2 block of pixels in FIG. 11A corresponds to a single pixel in FIG. 11B.

In a standard mode reduction, the color densities of the pixels in each 2×2 block are averaged to determine the color density of the corresponding pixel in the reduced image data. For example, for if the color densities of the four pixels in a 2×2 block is 1, 2, 2, and 3, the average is equal to 2, which would be used as the color density for the color density of the corresponding pixel in the reduced image data.

In the toner saving mode reduction of FIG. 11B, however, the color density of a pixel in the reduced image data is set to the lowest of the four color densities in the corresponding 2×2 block of pixels in the original image data. For example, the 2×2 block including pixels (5,5), (5,6), (6,5), and (6,6) in FIG. 11A have color densities of 3, 4, 4, 4, respectively. Accordingly, the lowest color density for this block is 3. The pixel in FIG. 11B corresponding to this 2×2 block is (3,3), which is shown to have a color density of 3. Since the lowest color density present in a 2×2 block of pixels will be less than or equal to the average color density, the color densities of the pixels using the toner saving mode reduction will be less than or equal to the color densities of the corresponding pixels using the standard mode reduction. As a result of using the toner saving mode reduction, less toner is used to reproduce the image data than by using the standard mode reduction.

The expansion/reduction resolution conversion unit 312 can determine which expansion or reduction process to apply to the image data based on the tag received from the image type interpreter 300. For example, the standard mode expansion or reduction can be applied for some image types, and the toner saving mode expansion or reduction for other image types. The expansion/reduction resolution conversion unit 312 can also be responsive to a setting of the image forming apparatus identifying whether the image data should be reproduced in a standard mode or a toner saving mode, and thus use the standard mode expansion/reduction or the toner saving mode expansion/reduction, respectively. Even if in the toner saving mode, the standard mode expansion/reduction may be used if the tag identifies the image data as being a particular type for which toner saving should not be applied by the expansion/reduction resolution conversion unit 312.

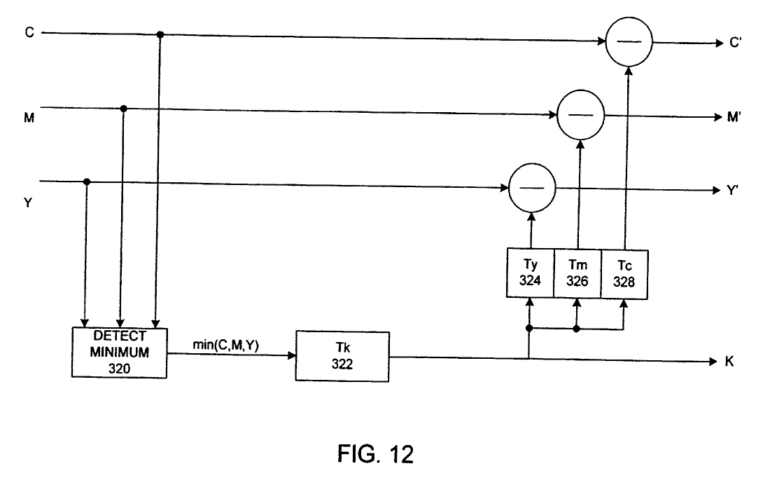

In addition to the toner saving processes implemented by the elements of the toner reduction system of FIG. 3, other toner saving process can also be implemented. For example, the color conversion unit 302 can be configured to perform a toner saving when performing black generation and under color removal (BG/UCR). FIG. 12 is a block diagram of a BG/UCR system consistent with the present invention. As shown in FIG. 12, cyan (C), magenta (M) and Yellow (Y) data are provided to a detect minimum unit 320. The CMY data can be image data that has been converted from RGB data or other type of image data by the color conversion unit 302. The detect minimum unit 320 detects which of the three color densities is the minimum or lowest and outputs the value min(C,M,Y) corresponding to the detected minimum. The value min(C,M,Y) is provided to Tk unit 322.

The Tk unit 322 uses the value min(C,M,Y) as an input for determining the K (black) data, i.e., the color density for black. The Tk unit 322 can be configured as a lookup table that determines the K data according to the inputted value min(C,M,Y). The Tk unit 322 is also preferably configured to determine a K data that has a lower color density than a standard process for determining the K data from the CMY data. The determined K data is output from the Tk unit 322, which provides the K data as an input to Ty unit 324, Tm unit 326, and Tc unit 328, as well as to an output of the BG/UCR system.

The Ty unit 324, Tm unit 326, and Tc unit 328 use the received K data to determine adjustment factors Ty(k), Tm(k), and Tc(k), respectively. Similar to the Tk unit 322, the Ty unit 324, Tm unit 326, and Tc unit 328 can be configured as lookup tables that determine the applicable adjustment factor according to the inputted K value. The Ty unit 324, Tm unit 326, and Tc unit 328 output the determined adjustment factors Ty(k), Tm(k), and Tc(k) to respective subtractors. The subtractors reduce the color density of the CMY data by the respective adjustment factors Tc(k), Tm(k), and Ty(k) to generate C′M′Y′ data, which is output from the BG/UCR system along with the K data. The reduction of the CMY data by the adjustment factors Ty(k), Tm(k), and Tc(k) results in the C′M′Y′ having lower color densities than the original CMY data.

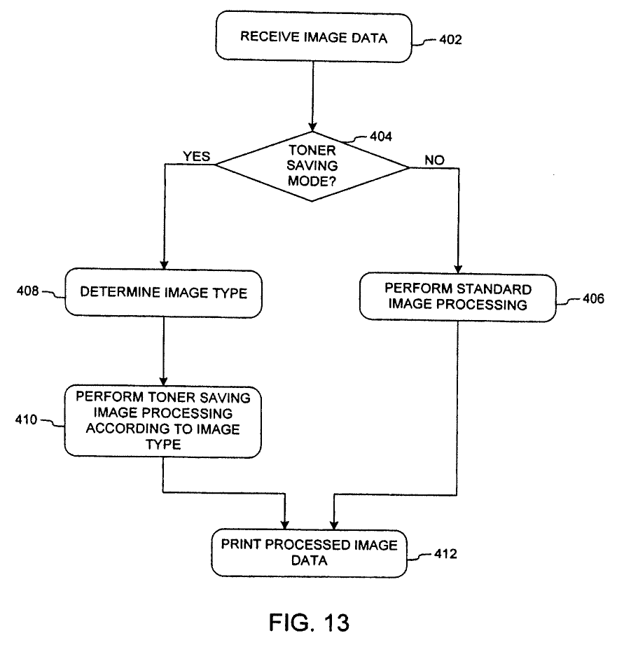

FIG. 13 is a flow diagram of a toner reduction process consistent with the present invention. As shown in FIG. 13, the process first receives image data to be reproduced or printed (Step 402). The image data can be from a document being scanned by the image forming apparatus, from a document being scanned by a scanner independent of the image forming apparatus, from a document or image stored in a file server, PC, or any type of storage device in response to a print request, from a fax, or from any device capable of providing image data to the toner reduction system. The image data can be color (such as RGB data) or black and white (B/W), and in any type of image format, such as JPEG, GIF or other formats.

The toner reduction process determines whether the received image data is to be reproduced in a toner saving mode (step 404). The toner reduction system may have a default setting to apply use the toner saving mode for all image reproductions. Alternatively, as part of the image reproduction or print request, the user includes a parameter or setting to use the toner saving mode. For example, when making a copy of a document, in addition to setting normal copy parameters such as number of copies, enlargement/reduction, stapling, and collating, the user can also set the parameter to use the toner saving mode. Similarly, the user can set the parameter to use the toner saving mode when making a print request.

If the received image data is to be reproduced in a standard mode, i.e., not a toner saving mode, then the received image data is subjected to a normal or standard image processing (step 406). The standard mode image processing does not use the toner saving processes as described above with respect to the toner reduction system of FIG. 3 and the corresponding toner saving algorithms described above with respect to FIG. 4A-FIG. 12. Rather, the standard mode image processing uses the conventional or standard image processing techniques.

If the toner saving mode is activated or selected, the toner saving process determines the image type for the received image data (step 408). As described above, the image type interpreter 300 is configured to determine the image type of the image data. The image type can be, for example, text, graphics, photo, or other known image types. In general, the image type can be determined according to the content of the image data itself. More specifically, to make the image type determination, the image type interpreter 300 can be configured to analyze the image data using any of a number of available algorithms or processes as are known to one skilled in the art for determining image type. It is also possible for the image type to be identified by user in the image reproduction or print request. As a result of the determination, the image type interpreter 300 generates a tag indicative of the determined image type of the received image data that is received by the elements of the toner reduction system of FIG. 3. The tag can be used to determine if an element of the toner reduction system should process the image data in a toner saving mode or in a standard mode.

The received image data is subject to image processing in the toner saving mode in accordance with the determined image type (step 410). The toner saving mode can include using each of the toner saving processes described above with respect to the gamut used by the color conversion unit 302, the gamma curve used for gamma correction by the CD/TF unit 304, the mask pattern used in the halftone processing unit 306, the line thinning and smoothing performed by the line thinning/smoothing unit 308, the mask pattern of the engine ASIC 310, the expansion or reduction by the expansion/reduction resolution conversion unit 312, or the black generation/under color removal of the BG/UCR system of FIG. 12. It is also possible that a subset of the toner saving processes, or only one of the toner saving processes is used when subjecting the image data to image processing.

In addition, the image type can be used to determine which, if any, of the toner saving processes to apply to the image data. For example, text data may be subjected only to the toner saving line thinning process of the line thinning/smoothing unit 308, graphic data may be subjected only to the use of the mask in the halftone processing unit 306, and photo data may be subjected only to the reduced destination gamut of the color conversion unit 302. It is also possible for different combinations of toner saving processes to be applied in accordance with the image type. For example, text data may be subjected to both the toner saving line thinning process and the toner saving gamma correction curve, graphic data may be subjected to both the mask in the halftone process and the toner saving line thinning process, and photo data may be subjected to both the reduced destination gamut and the mask in the halftone process. In general, the toner saving processes applied to the image data are selected to generate the best output according to the identified image type.

After performing the image processing of the image data, either in the standard or toner saving mode, the image data is printed (step 412). If the toner reduction system is implemented in the image forming apparatus, then the image data can be printed by the printer portion 2 of the image forming apparatus. Alternatively, if the toner reduction system is independent of the image forming apparatus, then the processing image data can be provided to the image forming apparatus which prints the received image data.

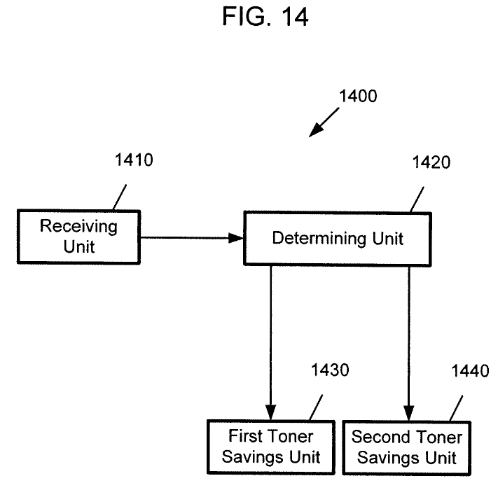

An apparatus 1400 according to one embodiment of the invention is shown in FIG. 14. A receiving unit 1410 receives image data for an image to be reproduced. A determining unit 1420 determines a mode of operation for performing the image reproduction. A first toner savings unit 1430 performs a first toner savings function if the determining unit 1420 determines that the image type is a first image type. A second toner savings unit 1440 performs a second toner savings function that is different from the first toner savings function, if the determining unit 1420 determines that the image type is a second image type that is different from the first image type.

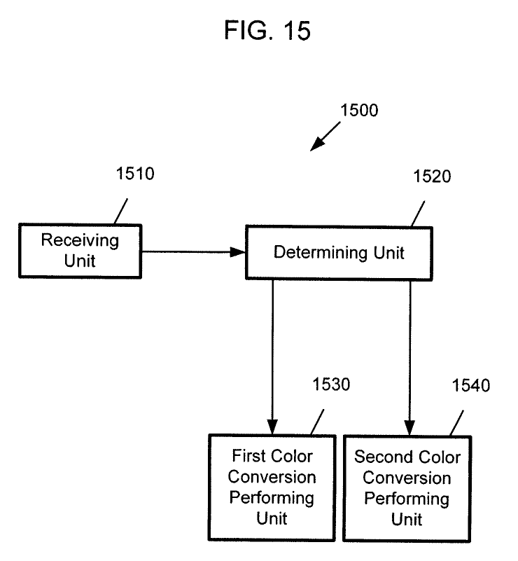

An apparatus 1500 according to another embodiment of the invention is shown in FIG. 15. A receiving unit 1510 receives image data for an image to be reproduced. A determining unit 1520 determines a mode of operation for performing the image reproduction. A first color conversion performing unit 1530 performs color conversion of the received image data using a first gamut having a first size if the determined mode is a first mode. A second color conversion performing unit 1540 performs color conversion of the received image data using a second gamut having a second size, smaller than the first size, if the determined mode is a second mode, different from the first mode.

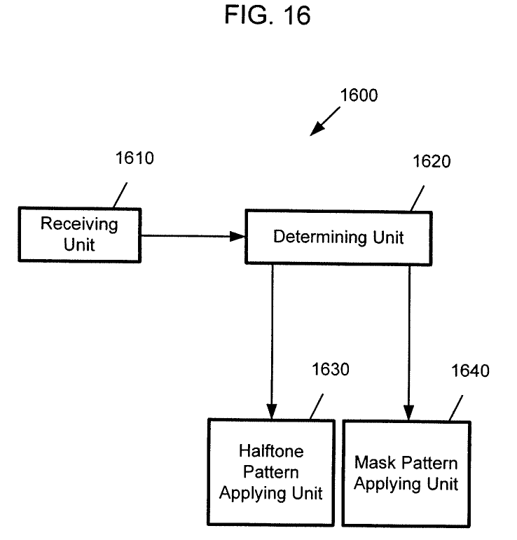

An apparatus 1600 according to yet another embodiment of the invention is shown in FIG. 16. A receiving unit 1610 receives image data for an image to be reproduced. A determining unit 1620 determines a mode of operation for performing the image reproduction. A halftone pattern applying unit 1630 applies a halftone pattern to the received image data if the determined mode is a first mode or a second mode, different from the first mode. A mask pattern applying unit 1640 applies a mask pattern to the result of the application of the halftone pattern only if the determined mode is the second mode.

The foregoing description of a preferred embodiment of the invention has been presented for purposes of illustration and description. It is not intended to be exhaustive or to limit the invention to the precise form disclosed, and modifications and variations are possible in light in the above teachings or may be acquired from practice of the invention. The embodiment was chosen and described in order to explain the principles of the invention and as practical application to enable one skilled in the art to utilize the invention in various embodiments and with various modifications are suited to the particular use contemplated. It is intended that the scope of the invention be defined by the claims appended hereto and their equivalents.

What is claimed is:

1. A method for controlling an amount of toner used to reproduce an image in an image forming apparatus, comprising:
receiving image data for an image to be reproduced;
determining an image type for the received image data;
using a first toner saving function if the determined image type is a first image type; and
using a second toner saving function, different from the first toner saving function, if the determined image type is a second image type, different from the first image type.

2. A method according to claim 1, wherein the first image type and the second image type are respectively one of text, graphics, or photo.

3. A method according to claim 1, further comprising determining if the image forming apparatus is operating in a toner saving mode or a standard mode.

4. A method according to claim 3, further comprising using the first or second toner saving function only if the image forming apparatus is determined to be in a toner saving mode.

5. A method according to claim 3, further comprising:
performing color conversion of the received image data using a first gamut having a first size if operating in the standard mode; and
performing the first or second toner saving function if operating in the toner saving mode,
wherein at least one of the first or second toner saving functions comprises performing color conversion of the received image data using a second gamut having a second size, smaller than the first size.

6. A method according to claim 3, further comprising:
performing gamma correction of the received image data using a first gamma correction curve having a first maximum if operating in the standard mode; and
performing the first or second toner saving function if operating in the toner saving mode,
wherein at least one of the first or second toner saving functions comprises performing gamma correction of the received image data using a second gamma correction curve having a second maximum, lower than the first maximum.

7. A method according to claim 3, further comprising:
performing line thinning of the received image data by reducing a thickness of a line by a first predetermined amount if operating in the standard mode; and
performing the first or second toner saving function if operating in the toner saving mode,
wherein at least one of the first or second toner saving functions comprises performing line thinning of the received image data by reducing a thickness of a line by a second predetermined amount greater than the first predetermined amount.

8. A method according to claim 3, further comprising:
performing line smoothing of the received image data by adding portions and removing portions of equal sizes to slanted lines if operating in the standard mode; and
performing the first or second toner saving function if operating in the toner saving mode,
wherein at least one of the first or second toner saving functions comprises performing line smoothing of the received image data by adding and removing portions of different sizes to slanted lines, the size of the added portions being smaller than the size of the removed portions.

9. A method according to claim 3, further comprising:
applying a periodic mask to the received image data if operating in the standard mode; and
performing the first or second toner saving function if operating in the toner saving mode,
wherein at least one of the first or second toner saving functions comprises applying a stochastic mask to the received image data.

10. A method according to claim 3, further comprising:
performing an N:1 reduction of the received image data by setting a color density of a pixel in the reduced image data to an average of color densities of a corresponding N×N block of pixels in the original image data, N being an integer greater than 1; and
performing the first or second toner saving function if operating in the toner saving mode,
wherein at least one of the first or second toner saving functions comprises performing an N:1 reduction of the received image data by setting a color density of a pixel in the reduced image data to a lowest color density present in a corresponding N×N block of pixels in the original image data.

11. A method according to claim 1, wherein at least one of the first or second toner saving functions comprises a halftone processing function, the halftone processing function comprising:
performing halftone processing of the received image data based on a halftone pattern; and
applying a mask pattern to the result of the halftone processing.

12. A method according to claim 1, wherein at least one of the first or second toner saving functions comprises a black generation/under color removal function, the black generation/under color removal function comprising:
determining a lowest color density of a pixel of CMY data;
determining a color density for K data of the pixel based on the determined lowest color density;
determining respective adjustment factors for the CMY data based on the determined color density for the K data; and
reducing the color densities of the CMY data by the determined respective adjustment factors.

13. A method according to claim 12, wherein the color density for the K data is determined from a lookup table, and the adjustment factors for the CMY data are determined from respective lookup tables.

14. A method according to claim 1, wherein the first toner saving function comprises a combination of at least two of a reduced gamut for color conversion, a gamma correction with a reduced maximum limit, a halftone processing using a mask pattern applied to a result of the halftone processing, and a line thinning with a greater reduction in line thickness, and
wherein the second toner saving function comprises a different combination of at least two of a reduced gamut for color conversion, a gamma correction with a reduced maximum limit, a halftone processing using a mask pattern applied to a result of the halftone processing, and a line thinning with a greater reduction in line thickness.

15. A method for controlling an amount of toner used in forming an image reproduction, comprising:
receiving image data for an image to be reproduced;
determining a mode of operation for performing the image reproduction;
performing color conversion of the received image data using a first gamut having a first size if the determined mode is a first mode; and
performing color conversion of the received image data using a second gamut having a second size, smaller than the first size, if the determined mode is a second mode, different from the first mode.

16. A method according to claim 15, wherein the first mode is a standard mode, and the second mode is a toner saving mode.

17. A method according to claim 15, further comprising:
receiving an image reproduction request including a mode selection, the mode selection identifying either the first mode or the second mode for performing the image reproduction,
wherein the step of determining the mode includes identifying the mode from the mode selection in the image reproduction request.

18. A method according to claim 15, wherein the shape of the first gamut and the second gamut are the same.

19. A method for controlling an amount of toner used in forming an image reproduction, comprising:
receiving image data for an image to be reproduced;
determining a mode of operation for performing the image reproduction;
applying a halftone pattern to the received image data if the determined mode is a first mode or a second mode, different from the first mode; and
applying a mask pattern to the result of the application of the halftone pattern only if the determined mode is the second mode.

20. A method according to claim 19, wherein the first mode is a standard mode, and the second mode is a toner saving mode.

21. A method according to claim 19, further comprising:
receiving an image reproduction request including a mode selection, the mode selection identifying either the first mode or the second mode for performing the image reproduction,
wherein the step of determining the mode includes identifying the mode from the mode selection in the image reproduction request.

22. An image forming apparatus for controlling an amount of toner used to reproduce an image, comprising:
a receiving unit configured to receive image data for an image to be reproduced;
a determining unit configured to determine an image type for the received image data;
a first toner savings unit configured to perform a first toner savings function if the determining unit determines that the image type is a first image type; and
a second toner savings unit configured to perform a second toner savings function that is different from the first toner savings function, if the determining unit determines that the image type is a second image type that is different from the first image type.

23. An image forming apparatus according to claim 22, wherein the first image type and the second image type are respectively one of text, graphics, or photo.

24. An image forming apparatus according to claim 22, wherein the determining unit determines if the image forming apparatus is operating in a toner saving mode or a standard mode.

25. An image forming apparatus according to claim 24, wherein the determining unit determines to use either the first or second toner saving function only if the image forming apparatus is operating in a toner saving mode.

26. An image forming apparatus according to claim 24, further comprising:
a color conversion performing unit configured to perform color conversion of the received image data using a first gamut having a first size if operating in the standard mode,
wherein the color conversion performing unit performs the first or second toner saving function if operating in the toner saving mode, and
wherein at least one of the first or second toner saving functions comprises functions for performing color conversion of the received image data using the color conversion performing unit that uses a second gamut having a second size, smaller than the first size.

27. An image forming apparatus according to claim 24, further comprising:
a gamma correction unit configured to perform gamma correction of the received image data using a first gamma correction curve having a first maximum if operating in the standard mode,
wherein the first or second toner saving function is performed if operating in the toner saving mode, and
wherein at least one of the first or second toner saving functions comprises functions for performing gamma correction of the received image data using the gamma correction unit that uses a second gamma correction curve having a second maximum, lower than the first maximum.

28. An image forming apparatus according to claim 24, further comprising:
a line thinning performing unit configured to perform line thinning of the received image data by reducing a thickness of a line by a first predetermined amount if operating in the standard mode,
wherein the first or second toner saving function is performed if operating in the toner saving mode, and
wherein at least one of the first or second toner saving functions comprises functions for performing line thinning of the received image data using the line thinning performing unit by reducing a thickness of a line by a second predetermined amount greater than the first predetermined amount.

29. An image forming apparatus according to claim 24, further comprising:
a line smoothing unit configured to perform line smoothing of the received image data by adding portions and removing portions of equal sizes to slanted lines if operating in the standard mode,
wherein the first or second toner saving function is performed if operating in the toner saving mode, and
wherein at least one of the first or second toner saving functions comprises functions for performing line smoothing of the received image data using the line smoothing unit by adding and removing portions of different sizes to slanted lines, the size of the added portions being smaller than the size of the removed portions.

30. An image forming apparatus according to claim 24, further comprising:
means for applying a periodic mask to the received image data if operating in the standard mode,
wherein the first or second toner saving function is performed if operating in the toner saving mode, and
wherein at least one of the first or second toner saving functions comprises functions for applying a stochastic mask using the periodic mask applying means to the received image data.

31. An image forming apparatus according to claim 24, further comprising:
means for performing an N:1 reduction of the received image data by setting a color density of a pixel in the reduced image data to an average of color densities of a corresponding N×N block of pixels in the original image data, N being an integer greater than 1,
wherein the first or second toner saving function is performed if operating in the toner saving mode, and
wherein at least one of the first or second toner saving functions comprises functions for performing an N:1 reduction of the received image data using the performing means by setting a color density of a pixel in the reduced image data to a lowest color density present in a corresponding N×N block of pixels in the original image data.

32. An image forming apparatus according to claim 22, wherein at least one of the first or second toner saving functions comprises a halftone processing function, the halftone processing function comprising:
a function for performing halftone processing of the received image data based on a halftone pattern; and
a function for applying a mask pattern to the result of the halftone processing.

33. An image forming apparatus according to claim 22, wherein at least one of the first or second toner saving functions comprises a black generation/under color removal function, the black generation/under color removal function comprising:
a function for determining a lowest color density of a pixel of CMY data;
a function determining a color density for K data of the pixel based on the determined lowest color density;
a function for determining respective adjustment factors for the CMY data based on the determined color density for the K data; and
a function for reducing the color densities of the CMY data by the determined respective adjustment factors.

34. An image forming apparatus according to claim 33, further comprising a lookup table, wherein the color density for the K data is determined from the lookup table, and the adjustment factors for the CMY data are determined from respective lookup tables.

35. An image forming apparatus according to claim 22, wherein the first toner saving function comprises a combination of at least two of a reduced gamut for color conversion, a gamma correction with a reduced maximum limit, a halftone processing using a mask pattern applied to a result of the halftone processing, and a line thinning with a greater reduction in line thickness, and
wherein the second toner saving function comprises a different combination of at least two of a reduced gamut for color conversion, a gamma correction with a reduced maximum limit, a halftone processing using a mask pattern applied to a result of the halftone processing, and a line thinning with a greater reduction in line thickness.

36. An image forming apparatus that controls an amount of toner used in forming an image reproduction, comprising:
a receiving unit configured to receive image data for an image to be reproduced;
a determining unit configured to determine a mode of operation for performing the image reproduction;
a first color conversion performing unit configured to perform color conversion of the received image data using a first gamut having a first size if the determined mode is a first mode; and
a second color conversion performing unit configured to perform color conversion of the received image data using a second gamut having a second size, smaller than the first size, if the determined mode is a second mode, different from the first mode.

37. An image forming apparatus according to claim 36, wherein the first mode is a standard mode, and the second mode is a toner saving mode.

38. An image forming apparatus according to claim 36, further comprising:
means for receiving an image reproduction request including a mode selection, the mode selection identifying either the first mode or the second mode for performing the image reproduction,
wherein the determining unit determines the mode of operation from the mode selection in the image reproduction request.

39. An image forming apparatus according to claim 36, wherein the shape of the first gamut and the second gamut are the same.

40. An image forming apparatus that controls an amount of toner used in forming an image reproduction, comprising:
a receiving unit configured to receive image data for an image to be reproduced;
a determining unit configured to determine a mode of operation for performing the image reproduction;
a halftone pattern applying unit configured to apply a halftone pattern to the received image data if the determined mode is a first mode or a second mode, different from the first mode; and
a mask pattern applying unit configured to apply a mask pattern to the result of the application of the halftone pattern only if the determined mode is the second mode.

41. An image forming apparatus according to claim 40, wherein the first mode is a standard mode, and the second mode is a toner saving mode.

42. An image forming apparatus according to claim 40, further comprising:
means for receiving an image reproduction request including a mode selection, the mode selection identifying either the first mode or the second mode for performing the image reproduction,
wherein the determining unit determines the mode of operation from the mode selection in the image reproduction request.
